(19) United States
(12) Patent Application Publication
(10) Pub. No.: US 2017/0345013 A1
(43) Pub. Date: Nov. 30, 2017

(54) REGISTRATION OF A PRODUCT HAVING AN ELECTRONIC LOCK

(71) Applicant: International Business Machines Corporation, Armonk, NY (US)

(72) Inventors: Sandip Datta, Kolkata (IN); Pankaj S. Dayama, Bangalore (IN); Jaikrishnan Harihara Subramania Iyer, Bangalore (IN); Vinayaka Pandit, Bangalore (IN)

(21) Appl. No.: 15/166,676

(22) Filed: May 27, 2016

(51) Int. Cl. G06Q 30/00

(52) U.S. Cl. CPC G06Q 30/012; G06Q 30/0185

(57) ABSTRACT

One embodiment provides a method, including: utilizing at least one processor to execute computer code that performs the steps of: obtaining at least one image corresponding to packaging of a product having a warranty, wherein the packaging comprises a digital lock; transmitting the at least one image to a verification entity for packaging tamper detection; receiving an electronic key for unlocking the digital lock after the verification entity determines that the packaging has not been tampered; and providing registration information for the product to a warranty registration database, wherein the registration information comprises a date of registration, product information, and information associated with the electronic key. Other aspects are described and claimed.

### BACKGROUND

Some products that consumers buy have warranties associated with them. For example, a user may buy a car battery which has a manufacturer's warranty that allows the consumer to receive a new battery or compensation if the battery fails within the warranty period. As another example, a consumer may purchase an appliance having a warranty. In order to activate the warranty the consumer may have to register the product, thereby providing the warranty with a starting date. If the consumer has a warranty claim, the consumer then contacts the manufacturer to submit the warranty claim.

For some products, the seller or retailer of the product may register the product for the warranty claims. In some cases, the seller or retailer of the product may register the product when the product is sold. The retailer may also keep a database of when products are sold. When the consumer brings the product to the retailer for a warranty claim, the retailer can look up the sale in the database to identify the date of sale. In these cases, the consumer brings the product to the retailer for the warranty claim and the retailer then receives reimbursement from the manufacturer under the warranty claim.

### BRIEF SUMMARY

In summary, one aspect of the invention provides a method, comprising: utilizing at least one processor to execute computer code that performs the steps of: obtaining at least one image corresponding to packaging of a product having a warranty, wherein the packaging comprises a digital lock; transmitting the at least one image to a verification entity for packaging tamper detection; receiving an electronic key for unlocking the digital lock after the verification entity determines that the packaging has not been tampered; and providing registration information for the product to a warranty registration database, wherein the registration information comprises a date of registration, product information, and information associated with the electronic key.

Another aspect of the invention provides an apparatus, comprising: at least one processor; and a computer readable storage medium having computer readable program code embodied therewith and executable by the at least one processor, the computer readable program code comprising: computer readable program code that obtains at least one image corresponding to packaging of a product having a warranty, wherein the packaging comprises a digital lock; computer readable program code that transmits the at least one image to a verification entity for packaging tamper detection; computer readable program code that receives an electronic key for unlocking the digital lock after the verification entity determines that the packaging has not been tampered; and computer readable program code that provides registration information for the product to a warranty registration database, wherein the registration information comprises a date of registration, product information, and information associated with the electronic key.

An additional aspect of the invention provides a computer program product, comprising: a computer readable storage medium having computer readable program code embodied therewith, the computer readable program code comprising: computer readable program code that obtains at least one image corresponding to packaging of a product having a warranty, wherein the packaging comprises a digital lock; computer readable program code that transmits the at least one image to a verification entity for packaging tamper detection; computer readable program code that receives an electronic key for unlocking the digital lock after the verification entity determines that the packaging has not been tampered; and computer readable program code that provides registration information for the product to a warranty registration database, wherein the registration information comprises a date of registration, product information, and information associated with the electronic key.

A further aspect of the invention provides a method, comprising: receiving a request for selling a product having packaging comprising an electronic lock; transmitting images of the packaging for tamper detection; receiving an unlock key for the electronic lock based upon a determination that the packaging has not been tampered with; registering, at a registration database, the product, wherein registering comprises adding product information, a date of sale of the product, and the unlock key to the registration database; and unlocking, using the unlock key, the electronic lock.

For a better understanding of exemplary embodiments of the invention, together with other and further features and advantages thereof, reference is made to the following description, taken in conjunction with the accompanying drawings, and the scope of the claimed embodiments of the invention will be pointed out in the appended claims.

### BRIEF DESCRIPTION OF THE SEVERAL VIEWS OF THE DRAWINGS

FIG. 1 illustrates a method of registering a product having an electronic lock.

FIG. 2 illustrates a method of verifying a warranty claim.

FIG. 3 illustrates a computer system.

### DETAILED DESCRIPTION

It will be readily understood that the components of the embodiments of the invention, as generally described and illustrated in the figures herein, may be arranged and designed in a wide variety of different configurations in addition to the described exemplary embodiments. Thus, the following more detailed description of the embodiments of the invention, as represented in the figures, is not intended to limit the scope of the embodiments of the invention, as claimed, but is merely representative of exemplary embodiments of the invention.

Reference throughout this specification to “one embodiment” or “an embodiment” (or the like) means that a particular feature, structure, or characteristic described in connection with the embodiment is included in at least one embodiment of the invention. Thus, appearances of the phrases “in one embodiment” or “in an embodiment” or the like in various places throughout this specification are not necessarily all referring to the same embodiment.

Furthermore, the described features, structures, or characteristics may be combined in any suitable manner in at least one embodiment. In the following description, numerous specific details are provided to give a thorough understanding of embodiments of the invention. One skilled in the relevant art may well recognize, however, that embodiments of the invention can be practiced without at least one of the specific details thereof, or can be practiced with other methods, components, materials, et cetera. In other instances, well-known structures, materials, or operations are not shown or described in detail to avoid obscuring aspects of the invention.

The illustrated embodiments of the invention will be best understood by reference to the figures. The following description is intended only by way of example and simply illustrates certain selected exemplary embodiments of the invention as claimed herein. It should be noted that the flowchart and block diagrams in the figures illustrate the architecture, functionality, and operation of possible implementations of systems, apparatuses, methods and computer program products according to various embodiments of the invention. In this regard, each block in the flowchart or block diagrams may represent a module, segment, or portion of code, which comprises at least one executable instruction for implementing the specified logical function(s).

It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

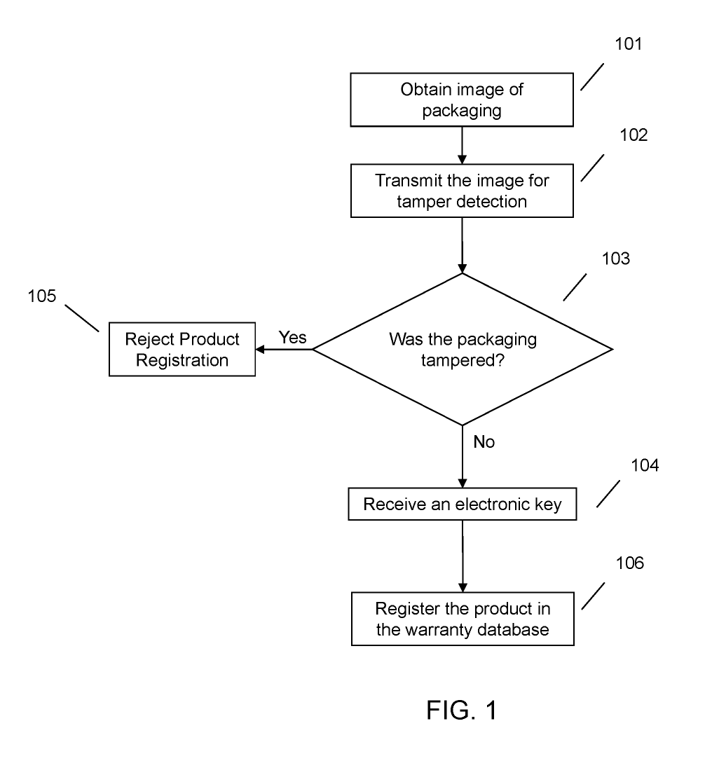

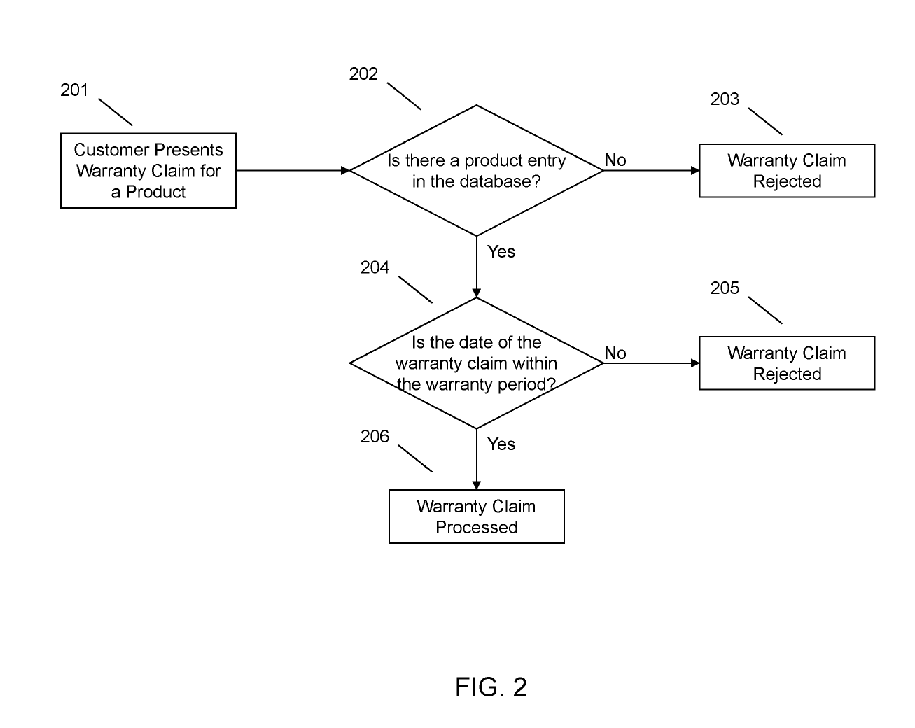

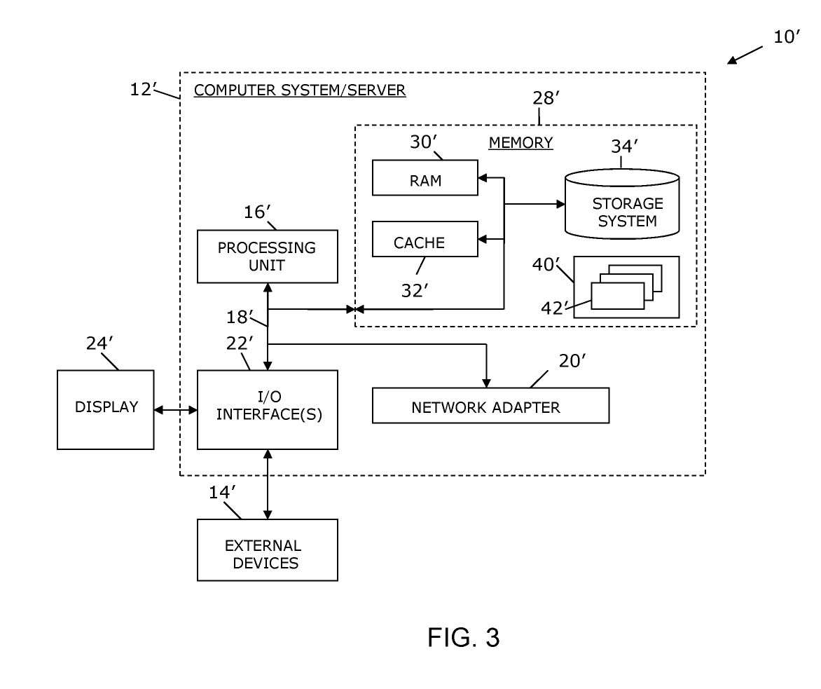

Specific reference will be made here below to FIGS. 1-2. It should be appreciated that the processes, arrangements and products broadly illustrated therein can be carried out on, or in accordance with, essentially any suitable computer system or set of computer systems, which may, by way of an illustrative and non-restrictive example, include a system or server such as that indicated at 12′ in FIG. 3. In accordance with an example embodiment, most if not all of the process steps, components and outputs discussed with respect to FIGS. 1-2 can be performed or utilized by way of a processing unit or units and system memory such as those indicated, respectively, at 16′ and 28′ in FIG. 3, whether on a server computer, a client computer, a node computer in a distributed network, or any combination thereof.

For some products when a consumer has a warranty claim, the consumer takes the product back to the retailer of the product. For example, in the case of car parts the consumer may buy the product from a retail store. If the product fails within the warranty period, rather than submitting a claim to the manufacturer, the consumer can take the part back to the retailer who then replaces the part and submits the warranty claim to the manufacturer. One problem with this approach is that the retailer does not generally have to, or chooses not to, register the product at the time of sale. Instead, the retailer usually keeps a list or database of the sales, for example, under the consumer's name, product serial number, product part number, and the like. When a consumer brings a product in for a warranty claim, the retailer looks up the product in the database to determine the date of sale. If the product was purchased within the warranty period, then the retailer reimburses the consumer the price of the product or replaces the product and then submits a warranty claim with the manufacturer of the product. The manufacturer then reimburses the retailer or replaces the product.

However, such an approach allows the retailer to change the date of sale to make it appear that the product was sold within the warranty period. In one case, the dealer may inform the consumer that the product is outside the warranty period and buy the product back for some minimal value or provide a minimal store credit to the consumer. The retailer may then submit a warranty claim having a date within the warranty period and get reimbursed from the manufacturer without providing anything or only a minimal amount to the consumer. In another case, the retailer and the consumer may work together to state an incorrect sale date that would be within the warranty period and split the reimbursement amount. The manufacturer has no way of verifying the sale date of the product. Additionally, the manufacturer cannot start the warranty period when the product is shipped to the retailer because the product may sit on a shelf for an extended amount of time before being sold to a consumer. The consumer would then lose the benefit of the entire warranty period. Thus, the manufacturers of products having warranties end up losing large amounts of money due to fraudulent warranty claims.

Accordingly, an embodiment provides a method of registering a product at the time of sale to initiate the warranty period. The product may be shipped from a manufacturer to a retailer in packaging and have an electronic lock. When a consumer wants to purchase the product, the retailer may take images (e.g., pictures, video, x-rays, etc.) of the product packaging. The images may then be uploaded or sent to a verification entity. For example, the verification entity may be the manufacturer of the product, a database having the ability to verify the images, and the like. The verification entity may then process or analyze the images to determine whether the packaging has been tampered with. For example, the entity may determine whether serial numbers on the packaging are intact, whether a tamper detection device has been activated, whether the packaging has been opened, and the like.

Upon verification that the packaging has not been tampered with, the retailer or consumer may receive an electronic key for unlocking the electronic lock. Additionally, the product may be registered in a warranty registration database. Registering the product in the database may include adding the product information (e.g., serial number, part number, manufacturer, etc.) to the database. In addition, the date of sale or registration and the electronic key may be included in the database. When a consumer later tries to submit a warranty claim, the product information for the product that the consumer is attempting to claim can be checked against the database. If the product information has been registered and the date of the warranty claim is within the warranty period, the retailer can then process the warranty claim. If, however, the product information or the date of the warranty claim is outside the warranty period, the warranty claim may be denied.

Such a system provides a technical improvement over current systems for warranty claim submissions because it provides a method and system to allow a manufacturer to verify that the product is actually within the warranty period. The system registers the product at the time of sale within the warranty registration database. When a warranty claim is then later submitted, the retailer or consumer cannot change the date of sale to ensure that the claim is within the warranty period. The manufacturer can ensure that the warranty claim is really valid for a product that was within the warranty period. Thus, the systems and methods as described herein guarantee that the manufacturer is only paying for valid warranty claims and is not losing money on warranty claims that were not actually within the warranty period.

Referring now to FIG. 1, an embodiment may obtain at least one image corresponding to packaging of a product. As an example, a retailer may receive a product that has been packaged (e.g., in a box, wrapped in paper, etc.) by the manufacturer. The packaging may also include an electronic lock. An electronic lock may include a lock that can be authenticated without using a physical key. Example types of electronic locks may include locks having a number pad for entry of a numerical or alphanumerical code, locks that can receive or read an electronic transmission (e.g., a code transmitted by an electronic device, a radio frequency transmission, a barcode or quick response code, etc.), a lock that can receive a security code, and the like. Another type of lock may include use of a physical device (e.g., a key card, key, electronic chip, etc.) that is used to unlock the lock. The physical device may then be activated or programmed by the application upon completed registration as discussed below. When the retailer receives the product, the retailer may have a particular time frame to return the product to the manufacturer if the packaging has been destroyed or tampered with. For example, if the packaging is damaged during shipment, the retailer may reject the product or may return the product within a time period specified by the manufacturer.

When a consumer wishes to purchase the product, the retailer may initiate a sequence on the electronic lock. For example, the lock may include a button to start the registration process. As another example, the retailer may just access or contact the manufacturer or another entity to indicate that the product is to be purchased by a consumer. As another example, the retailer may access a mobile application or registration application. Within the application the retailer may indicate which product is to be purchased. Alternatively, the application may be applicable to all products and the retailer may not have to designate the product to be purchased. The retailer may then be prompted to take images (e.g., pictures, video, x-ray, etc.) of the packaging. In one embodiment, the retailer may be prompted to take specific images or images from specific positions. For example, an embodiment may require images of all sides of the product. As another example, an embodiment may require images of product identification information (e.g., a machine readable optical label, serial numbers, quick response codes, barcodes, model information, manufacturer stickers, etc.) included on the packaging.

The retailer may then take images of the packaging of the product. If the retailer is using an application associated with the warranty registration, the application may automatically receive the images. Alternatively, an embodiment may obtain the images by retrieving or accessing the images, for example, from a storage location (e.g., remote data storage, local data storage, etc.), or may receive the images, for example, by a user uploading the images to a particular application or location.

At 102 an embodiment may transmit the images to a verification entity so that the verification entity can determine whether the packaging has been tampered with. For example, the verification entity may determine whether the packaging has been tampered with in such a way that the product may no longer be in the packaging. In one embodiment, the verification entity may include the manufacturer. For example, the images may be sent to the manufacturer so that the manufacturer can verify that the packaging is still intact. The verification entity may be a third party verification service. Alternatively, the verification entity may be a computer or other automated service that can analyze or process the images to determine whether the packaging has been tampered with.

At 103 the verification entity may determine whether the packaging has been tampered with. Determining whether the packaging has been tampered with may include identifying whether a tamper detection device has been activated. For example, the packaging may include a seal as a tamper detection device. If the seal has been activated (i.e., broken), a verification entity may identify that the packaging has been tampered with. Another example of a tamper detection device includes a tamper label or tape. If these are removed then a message or indicator is left on the surface of the packaging indicating that the label or tape was removed. In one embodiment, determining packaging tampering may include determining whether particular parts of the packaging are still intact. For example, a manufacturer may strategically place quick response labels or barcodes that would be damaged if the package is tampered with.

If, at 103, the verification entity determines that the packaging has been tampered with, the verification entity may reject or disallow the registration attempt by the retailer at 105. In determining whether the packaging has been tampered with, the entity may determine that the packaging includes some damage, but not enough to indicate the product has been damaged or is no longer in the packaging. For example, if the entity determines that a corner of the box is dented, the verification entity may determine that such tampering is not enough to reject the registration. In other words, some evidence of tampering or damage to the packaging may not automatically result in disallowance of registration. In other words, the damage or tampering of the packaging may have to reach a particular threshold, which may be set by the manufacturer, before it would result in disallowance of registration. On the other hand, the verification entity may disallow registration at the smallest sign of damage or tampering.

If, however, the verification entity determines that the packaging has not been tampered with at 103, the registration process may continue. At 104 an embodiment may receive an electronic key for unlocking the digital lock. For example, a code may be transmitted that can be entered at the electronic lock. As another example, a program may be transmitted that programs or activates the physical device associated with the lock. As an example, if the electronic device requires a key card having a radio frequency identification (RFID) chip embedded within the key card, the electronic key may include programming the RFID chip to work with the respective electronic lock. As another example, a transmission may be transmitted by the application that can be held close to the electronic lock. The transmission may then allow communication between the application and the electronic lock which then unlocks the lock. The electronic key can then be used by the retailer or consumer to unlock the electronic lock and thereby remove the packaging from the product.

At 106 the product may be registered in a warranty registration database. This database may house warranty and registration information for a particular manufacturer, for a particular retailer, for a particular product, for all products and retailers using an application, and the like. In registering the product, product information may be added to the database. For example, the quick response code for the product may be added, a serial number of the product may be added, the name of the retailer may be added, and other pertinent information that can be used to identify the product at a later time. In addition to the product information, the date of registration or sale may be added and associated with the product. In one embodiment, registering the product may include adding the electronic key or information associated with the electronic key (e.g., a transmission date or timestamp, electronic lock identification, etc.) to the warranty registration database. The database may also include the warranty time period associated with the product and warranty. Additional information related to the warranty may be included. For example, the database may include information related to the terms of the warranty, which parts of the product are covered under the warranty, and the like. As a note, receiving the electronic key at 104 and registering the product in a database at 106 may occur concurrently, in order, or in reverse order as that in FIG. 1.

Referring now to FIG. 2, a consumer or customer may present a warranty claim for a product at 201. For example, the consumer may return to the retailer because the product is no longer functioning correctly. The retailer may then enter the product information into the application or the database. As an alternative, the retailer may be able to scan the product machine readable optical label (e.g., quick response code, bar code, etc.) and that information may be transmitted to the database. At 202, an embodiment may determine whether the database contains an entry corresponding to the product. If there is no entry corresponding to the product in the database, an embodiment may reject the warranty claim at 203.

If, however, an entry does exist in the database for the product, an embodiment may verify whether the warranty claim is being made within the warranty period at 204. An embodiment may obtain the claim date and the registration or sale date. An embodiment may then calculate the warranty period and determine whether the claim date is within the warranty period. For example, if the sale date of the product was Jan. 1, 2000 and the warranty period is 3 years from the date of sale, an embodiment may determine that the warranty period ends on Jan. 1, 2003. An embodiment may then compare the date of the claim to the warranty period end date. If the claim date is after the warranty period end date an embodiment may reject the warranty claim at 205. For example, using the above example, if the claim date is Jan. 2, 2003, an embodiment may reject the warranty claim. If, however, the claim date is before the warranty end date or within the warranty period, an embodiment may allow for further processing or acceptance of the warranty claim at 206.

As shown in FIG. 3, computer system/server 12′ in computing node 10′ is shown in the form of a general-purpose computing device. The components of computer system/server 12′ may include, but are not limited to, at least one processor or processing unit 16′, a system memory 28′, and a bus 18′ that couples various system components including system memory 28′ to processor 16′. Bus 18′ represents at least one of any of several types of bus structures, including a memory bus or memory controller, a peripheral bus, an accelerated graphics port, and a processor or local bus using any of a variety of bus architectures. By way of example, and not limitation, such architectures include Industry Standard Architecture (ISA) bus, Micro Channel Architecture (MCA) bus, Enhanced ISA (EISA) bus, Video Electronics Standards Association (VESA) local bus, and Peripheral Component Interconnects (PCI) bus.

Computer system/server 12′ typically includes a variety of computer system readable media. Such media may be any available media that are accessible by computer system/server 12′, and include both volatile and non-volatile media, removable and non-removable media.

System memory 28′ can include computer system readable media in the form of volatile memory, such as random access memory (RAM) 30′ and/or cache memory 32′. Computer system/server 12′ may further include other removable/non-removable, volatile/non-volatile computer system storage media. By way of example only, storage system 34′ can be provided for reading from and writing to a non-removable, non-volatile magnetic media (not shown and typically called a “hard drive”). Although not shown, a magnetic disk drive for reading from and writing to a removable, non-volatile magnetic disk (e.g., a “floppy disk”), and an optical disk drive for reading from or writing to a removable, non-volatile optical disk such as a CD-ROM, DVD-ROM or other optical media can be provided. In such instances, each can be connected to bus 18′ by at least one data media interface. As will be further depicted and described below, memory 28′ may include at least one program product having a set (e.g., at least one) of program modules that are configured to carry out the functions of embodiments of the invention.

Program/utility 40′, having a set (at least one) of program modules 42′, may be stored in memory 28′ (by way of example, and not limitation), as well as an operating system, at least one application program, other program modules, and program data. Each of the operating systems, at least one application program, other program modules, and program data or some combination thereof, may include an implementation of a networking environment. Program modules 42′ generally carry out the functions and/or methodologies of embodiments of the invention as described herein.

Computer system/server 12′ may also communicate with at least one external device 14′ such as a keyboard, a pointing device, a display 24′, etc.; at least one device that enables a user to interact with computer system/server 12′; and/or any devices (e.g., network card, modem, etc.) that enable computer system/server 12′ to communicate with at least one other computing device. Such communication can occur via I/O interfaces 22′. Still yet, computer system/server 12′ can communicate with at least one network such as a local area network (LAN), a general wide area network (WAN), and/or a public network (e.g., the Internet) via network adapter 20′. As depicted, network adapter 20′ communicates with the other components of computer system/server 12′ via bus 18′. It should be understood that although not shown, other hardware and/or software components could be used in conjunction with computer system/server 12′. Examples include, but are not limited to: microcode, device drivers, redundant processing units, external disk drive arrays, RAID systems, tape drives, and data archival storage systems, etc.

This disclosure has been presented for purposes of illustration and description but is not intended to be exhaustive or limiting. Many modifications and variations will be apparent to those of ordinary skill in the art. The embodiments were chosen and described in order to explain principles and practical application, and to enable others of ordinary skill in the art to understand the disclosure.

Although illustrative embodiments of the invention have been described herein with reference to the accompanying drawings, it is to be understood that the embodiments of the invention are not limited to those precise embodiments, and that various other changes and modifications may be affected therein by one skilled in the art without departing from the scope or spirit of the disclosure.

The present invention may be a system, a method, and/or a computer program product. The computer program product may include a computer readable storage medium (or media) having computer readable program instructions thereon for causing a processor to carry out aspects of the present invention.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, or either source code or object code written in any combination of one or more programming languages, including an object oriented programming language such as Smalltalk, C++ or the like, and conventional procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions. These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

What is claimed is:

1. A method, comprising:
utilizing at least one processor to execute computer code that performs the steps of:
obtaining at least one image corresponding to packaging of a product having a warranty, wherein the packaging comprises a digital lock;
transmitting the at least one image to a verification entity for packaging tamper detection;
receiving an electronic key for unlocking the digital lock after the verification entity determines that the packaging has not been tampered; and
providing registration information for the product to a warranty registration database, wherein the registration information comprises a date of registration, product information, and information associated with the electronic key.

2. The method of claim 1, comprising receiving a warranty request for the product and verifying information associated with the product against the registration information contained within the warranty registration database.

3. The method of claim 2, comprising rejecting the warranty request if the information associated with the product is not contained within the warranty registration database.

4. The method of claim 2, comprising rejecting the warranty request if the warranty request is received outside a time period of the warranty.

5. The method of claim 1, wherein the at least one image comprises at least one image of an identification mark of the product included on the packaging.

6. The method of claim 5, wherein the identification mark comprises a machine readable optical label.

7. The method of claim 1, wherein the product information comprises a serial number of the product.

8. The method of claim 1, comprising unlocking the digital lock using the electronic key.

9. The method of claim 1, comprising recommending images to be obtained and wherein the obtaining comprises obtaining the recommended images.

10. The method of claim 1, wherein the packaging tamper detection comprises determining whether a tamper detection device has been activated.

11. An apparatus, comprising:
at least one processor; and
a computer readable storage medium having computer readable program code embodied therewith and executable by the at least one processor, the computer readable program code comprising:
computer readable program code that obtains at least one image corresponding to packaging of a product having a warranty, wherein the packaging comprises a digital lock;
computer readable program code that transmits the at least one image to a verification entity for packaging tamper detection;
computer readable program code that receives an electronic key for unlocking the digital lock after the verification entity determines that the packaging has not been tampered; and
computer readable program code that provides registration information for the product to a warranty registration database, wherein the registration information comprises a date of registration, product information, and information associated with the electronic key.

12. A computer program product, comprising:
a computer readable storage medium having computer readable program code embodied therewith, the computer readable program code comprising:
computer readable program code that obtains at least one image corresponding to packaging of a product having a warranty, wherein the packaging comprises a digital lock;
computer readable program code that transmits the at least one image to a verification entity for packaging tamper detection;
computer readable program code that receives an electronic key for unlocking the digital lock after the verification entity determines that the packaging has not been tampered; and
computer readable program code that provides registration information for the product to a warranty registration database, wherein the registration information comprises a date of registration, product information, and information associated with the electronic key.

13. The computer program product of claim 12, comprising computer readable program code that receives a warranty request for the product and verifies information associated with the product against the registration information contained within the warranty registration database.

14. The computer program product of claim 13, comprising computer readable program code that rejects the warranty request if the information associated with the product is not contained within the warranty registration database.

15. The computer program product of claim 13, comprising computer readable program code that rejects the warranty request if the warranty request is received outside a time period of the warranty.

16. The computer program product of claim 12, wherein the at least one image comprises at least one image of an identification mark of the product included on the packaging.

17. The computer program product of claim 16, wherein the identification mark comprises a machine readable optical label.

18. The computer program product of claim 12, wherein the product information comprises a serial number of the product.

19. The computer program product of claim 12, comprising unlocking the digital lock using the electronic key.

20. A method, comprising:
receiving a request for selling a product having packaging comprising an electronic lock;
transmitting images of the packaging for tamper detection;
receiving an unlock key for the electronic lock based upon a determination that the packaging has not been tampered with;
registering, at a registration database, the product, wherein registering comprises adding product information, a date of sale of the product, and the unlock key to the registration database; and
unlocking, using the unlock key, the electronic lock.
